(19) United States
(12) Patent Application Publication
(10) Pub. No.: US 2005/0031878 A1
(43) Pub. Date: Feb. 10, 2005

(54) Adhesion promoter concentrates

(76) Inventors: Vasanthakumar Narayanan, Morristown, TN (US); George S. Upton, Talbott, TN (US)

Correspondence Address: Brown Rudnick Berlack Israels LLP, One Financial Center, Box IP, Boston, MA, 02111, US

(21) Appl. No.: 10/738,524

(22) Filed: Dec. 16, 2003

Related U.S. Application Data
(60) Provisional application No. 60/492,148, filed on Aug. 4, 2003.

(51) Int. Cl. C09J 7/00

(52) U.S. Cl. 428/458; 428/461; 156/242; 156/327; 156/332; 156/334

(57) ABSTRACT

An adhesion promoter comprising a pentaerythritol ester of rosin or polymerized rosin incorporated in a functionalized ethylene copolymer, such as ethylene methylacrylate, is described herein. The adhesion promoter is used for thermal bonding the surfaces of two dissimilar substrates, such as aluminum, paper and film. The adhesion promoter can be used at a lower bonding temperature and enhances peel resistance.

### CROSS REFERENCE TO RELATED APPLICATIONS

This application claims the benefit of priority document 60/492,148, a U.S. Provisional Application filed Aug. 4, 2003.

### FIELD OF THE INVENTION

The present invention relates generally to extrudable melt adhesives. More particularly, the present invention relates to thermoplastic adhesion promoter concentrates.

### BACKGROUND OF THE INVENTION

The art of combining dissimilar materials to provide barrier properties, strength and aesthetics is well known in the flexible packaging industry. There has been a need for combining paper or aluminum foil/metallized film with polyethylene, polyester, nylon and various other polymers. The polymers may be combined with the foil either in the form of a blown or cast film made using lamination equipment or in the form of a molten curtain and subsequent solidification using an extrusion coating process. In any of these two methods, one needs to use an adhesive promoter composition, or “tie layer”, that will create functional bonds with the dissimilar materials.

There are numerous adhesive promoter resins currently used, depending on the application. Copolymers of ethylene acrylic acid (EAA) and ionomer resins neutralized with sodium, zinc or lithium are typically used for bonding foil or paper to polyolefin films. Ideally, resins contain polar functional groups which facilitate bonding, such as carbonyl, hydroxyl, ester, carboxylic acid and amine. Other tackified polymers are described in the prior art.

U.S. Pat. No. 5,021,113 (Jun. 4, 1991), issued to Sanders et al., describes a method for bonding polymer materials with an adhesive comprising a carboxylated block copolymer.

U.S. Pat. No. 5,095,065 (Mar. 10, 1992), issued to Yang, discloses a tackified acrylic copolymer latex incorporating a natural or petroleum hydrocarbon resin derived from a liquid monomer mixture. The monomer mixture comprises methyl acrylic acid and one or more alkyl methacrylate esters.

U.S. Pat. No. 5,516,843 (May 14, 1996), issued to Scholl, describes an adhesion promoter for improving the adherence of polysulfides to the surfaces of solid thermoplastic substrates. The adhesion promoter is a phenolic resin or chlorinated polyolefin.

U.S. Pat. No. 5,591,792 (Jan. 7, 1997), issued to Hattori et al., discloses an adhesive resin comprising an ethylene polymer and a block copolymer of a vinyl aromatic hydrocarbon.

European Patent No. EP 0 683 803 (May 2, 1997), issued to Raymond, describes a polyamide resin based on mixtures of organic acids and amine for promoting adhesion of polymer and copolymers.

European Patent No. EP 0 850 138 (May 31, 2000), issued to Jianella and assigned to Dow Chemical Company, discloses a laminate adhesion promoter comprising a linear polyolefin elastomer.

U.S. Pat. No. 6,228,504 (May 8, 2001), issued to Sawada et al., describes an adhesive resin composition comprising an ethylene/vinyl acetate copolymer, a styrene polymer and a tackifier.

U.S. Pat. No. 6,306,503 (Oct. 23, 2001), issued to Tsai, discloses a multilayer film comprising a fluoropolymer layer and a thermoplastic homopolymer or copolymer layer. An intermediate layer of an olefin-polymer and a styrene-containing rubber is also included in the film.

U.S. Pat. No. 6,500,556 (Dec. 31, 2002), issued to Morris et al., discloses an ethylene acid copolymer with enhanced adhesion. The copolymer is an extrudable adhesive that binds polar substrates such as metal foil, to non-polar substrates, such as polyethylene.

There exist numerous problems with current adhesive promoter compositions. Many currently available adhesive promoters have high viscosity and are hard to apply to substrates. The increased thickness of the material makes it difficult to evenly and thoroughly cover the entire surface to be bonded. Thicker adhesives require a higher melting temperature to properly adhere to the surfaces of the substrates, a situation which is neither practical nor energy efficient. This higher temperature can denature or destroy temperature-sensitive materials such as synthetic fabrics. In addition, many adhesive resins crystallize too fast and do not properly bond substrates.

The overall performance of an adhesive promoter is dictated by the ability of one substrate to not only bond to the other effectively at the time of application, but also in situations of high humidity or after water immersion of the substrates during use. Typically, commercially-available adhesives fail to maintain proper adhesion with the assortment of dissimilar substrates required by the packaging industry. This problem can lead to premature peeling of the adhesive from the substrate.

It is, therefore, desirable to provide a suitable adhesion promoter for use at lower temperatures among a wide variety of dissimilar substrates.

### SUMMARY OF THE INVENTION

It is an object of the present invention to obviate or mitigate at least one disadvantage of previous adhesion promoters.

In one aspect, the present invention provides a thermoplastic adhesion promoter concentrate for thermal bonding the surfaces of two dissimilar substrates comprising a pentaerythritol ester of rosin or polymerized rosin incorporated in a functionalized ethylene copolymer. The adhesion promoter of the present invention can be used to bond foil or paper to polyester, nylon and polyolefin polymers. Advantageously, the adhesion promoter is economical and practical as it can be applied to a wider assortment of substrates than currently-available adhesion promoters. Further, the adhesion promoter can be used at lower temperatures which translates into energy savings, minimized polymer degradation, elimination of gels and defects, reduction/elimination of flash-off of low molecular weight additives such as slip, antistat and UV stabilizer, and elimination of color pigment degradation. Finally, the adhesion promoter of the present invention can be prepared as a concentrate for enhanced user flexibility.

The adhesion promoter of the current invention comprises a tackifier additive with or without other olefinic or functionalized olefin copolymers for extrusion lamination or coating, blown film or cast film in mono or multiple layers as required.

Other aspects and features of the present invention will become apparent to those ordinarily skilled in the art upon review of the following description of specific embodiments of the invention.

### BRIEF DESCRIPTION OF THE FIGURES

FIG. 1 shows exemplary melting curves obtained from EAA and ionomer, contrasted with adhesion promoters AP 2 and AP 3 of the present invention.

FIG. 2 shows exemplary crystallization curves obtained from DSC cooling studies of the adhesion promoters of the present invention.

FIG. 3 shows exemplary FTIR curves of absorbance as a function of wave number in the analysis of adhesion promoters of the present invention.

FIG. 4 shows the intensity of carbon and oxygen signals obtained from X-ray analysis of EAA, ionomer, polyester film, low density polyethylene (LDPE), and adhesion promoters AP 2 and AP 3 of the present invention.

FIG. 5 shows the oxygen/carbon (O/C) ratio determined by X-ray fluorescence detection in one example of the present invention.

FIG. 6 is a graph of peel resistance for each of EAA, ionomer, AP 2 and AP 3, for metallized substrate bonded to PET film in one example of the present invention.

FIG. 7 is a graph of peel resistance for each of EAA, ionomer, AP 2 and AP 3, for metallized substrate bonded to paper in one example of the present invention.

### DETAILED DESCRIPTION

Generally, the present invention provides a novel thermoplastic adhesion promoter concentrate. Specifically, the invention provides a thermoplastic adhesion promoter concentrate for thermal bonding the surfaces of two dissimilar substrates comprising a pentaerythritol ester of rosin or polymerized rosin incorporated in a functionalized ethylene copolymer.

In one embodiment of the present invention, a stabilized pentaerythritol ester of rosin and polymerized rosin has been combined individually with a functional copolymer using a twin screw compounding process. Typically, the copolymer is ethylene methylacrylate (EMA), although other copolymers such as ethylene vinyl acetate (EVA), ethylene acrylic acid, ionomer or polyolefin resin can be used. EMA works well in a much larger temperature range, particularly at lower temperatures than conventional tie layers. Other olefinic polymers may be added but are not required. The melt temperature of the compounding process is kept between about 260° F. and about 400° F., optionally 360° F., to avoid any thermal degradation of the ingredients. In a preferred embodiment, the concentration of rosin ester used is typically about 1 to about 99% (w/w), preferably in the range of 5-95% (w/w), particularly preferably 30-50% (w/w).

The rosin alone is not tacky and must be combined with a polymer to add tack. Further, added polymer is necessary to maintain proper viscosity for applying the adhesion promoter. Ideally, the concentration of EMA used in the present invention is about 50% (w/w) to about 70% (w/w).

In a further aspect of the present invention, the adhesion promoter is generally used thermal bonding dissimilar substrates. The thermal bonding can be mono or multilayer extrusion coating and extrusion lamination, mono or multilayer blown or cast films. The adhesion promoter can be used as a monolayer curtain in extrusion coating for lamination or as an inner coextruded layer that contacts the primary substrate such as metal, paper or polymer composition. Common applications include paper/aluminum and aluminum/polyethylene.

In a further aspect, there is provided a film comprising a first layer bonded to a second layer with the adhesion promoter of the present invention. In one embodiment, the first and second layers are dissimilar. Typical layers include metal, paper and polymer compositions as defined herein.

The following examples are offered to further illustrate the various specific and preferred embodiments and techniques. It should be understood, however, that many variations and modifications may be made while remaining within the scope of the present invention.

### EXAMPLES

In all samples of the adhesion promoter (AP) of the present invention used in the test examples, the pentaerythritol rosin ester was SYLVALITE™ RE 100L from Arizona Chemical Co. and the EMA used was Optema™ TC-220 (5 Ml, 24% methyl acrylate content) from Exxon Mobil Chemical Company. In addition, a polymerized rosin from Arizona Chemical Co. with a trade name SYLVEROS™ PR 295 was used. For the purpose of the following examples, test compound “AP 2” contains 30% pentaerythritol rosin ester +70% EMA, and “AP 3” contains 50% polymerized rosin +50% EMA. For comparative purposes, prototypes containing an ionomer resin from DuPont called SURLYN™ 8120 (“ionomer” in the following examples) and an EAA copolymer called PRIMACOR™ 3440 from Dow Chemical Co. (“EAA” in the following examples) were used as tie layer resins.

### Example 1

To test bonding capabilities of the adhesion promoter of the present invention, samples of aluminum foil, paper and polyester film (5 mil, 6″ by 6″) were bonded with EAA, ionomer and AP. A Carver™ Laboratory Hydraulic Press Model was used to press the samples together for 30 seconds with a load of 5000 pounds at a temperature of 265° F. At this relatively low temperature, AP demonstrated excellent bonding to polyester film with minimal peeling, while EAA and ionomer did not bond at all. This may be indicative of strong chemical bonding with the AP and the film. There was good bonding of paper and foil with all samples.

### Example 2

Differential Scanning Calorimetry (DSC) was used to determine the melting and crystallization curves of EAA, ionomer and two adhesion promoters of the invention, AP 2 and AP 3. A TA Instruments™ DSC Q 100 was used for the analysis. Samples were heated from room temperature to 200° C. at a rate of 10° C./minute, followed by cooling from 200° C. to room temperature at the same rate.

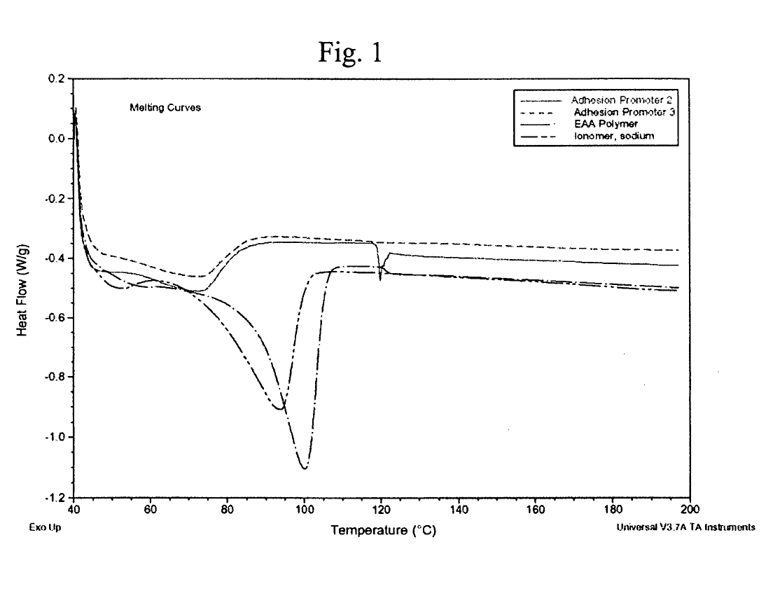

FIG. 1 shows melting curves obtained from EAA, ionomer, and adhesion promoters AP 2 and AP 3 of the present invention. Melting studies indicate that the faster melting rate of AP allows the material to be processed at temperatures below 400° F. (204° C.).

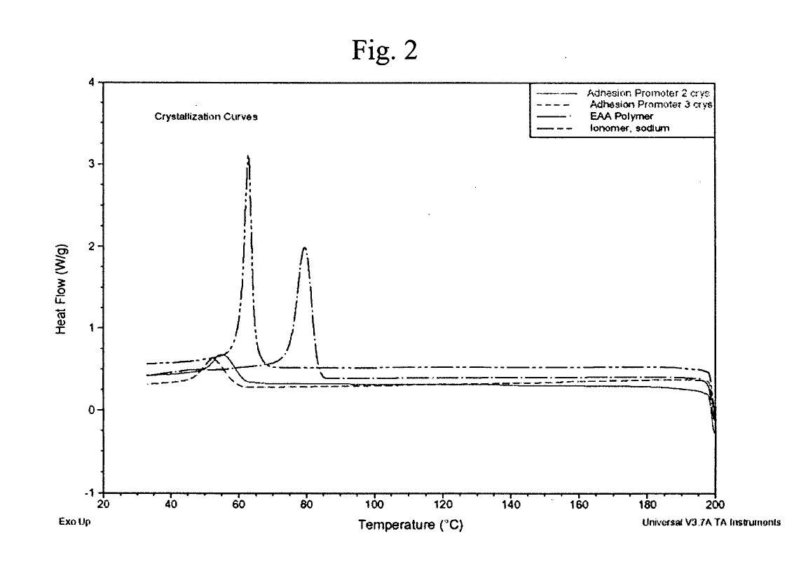

In FIG. 2, crystallization curves obtained from DSC cooling studies indicate that both APs of the present invention remain essentially amorphous after solidification.

### Example 3

Fourier Transform Infrared Spectroscopy (FTIR) was performed using a Biorad™ Excaliber series FTS 3000MX. FTIR was used to study transmission on films.

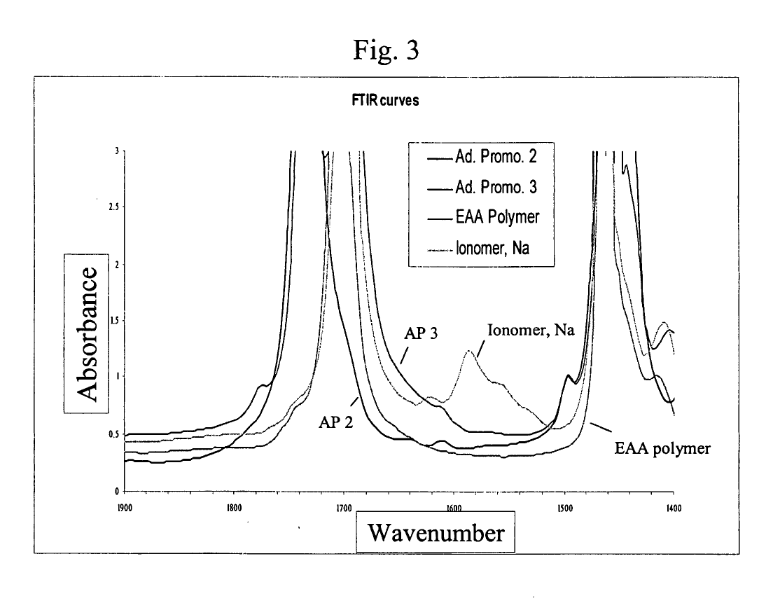

FIG. 3 indicates FTIR curves of absorbance as a function of wave number. Curves for EAA, ionomer, and adhesion promoters AP 2 and AP 3 of the present invention are shown.

### Example 4

X-ray fluorescence was performed using a Gresham Scientific™ SIRIUS 10/7.5 X-ray detector. The study was performed to determine the presence of carbon and oxygen groups on the bonding surface.

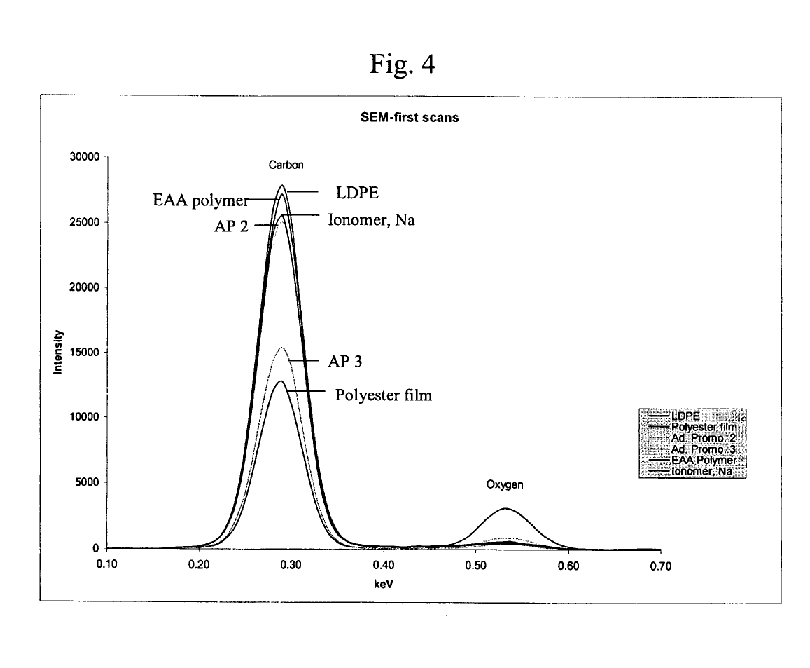

FIG. 4 shows one example of the intensity of carbon and oxygen signals obtained from X-ray analysis of EAA, ionomer, polyester film, low density polyethylene (LDPE), and adhesion promoters AP 2 and AP 3 of the present invention.

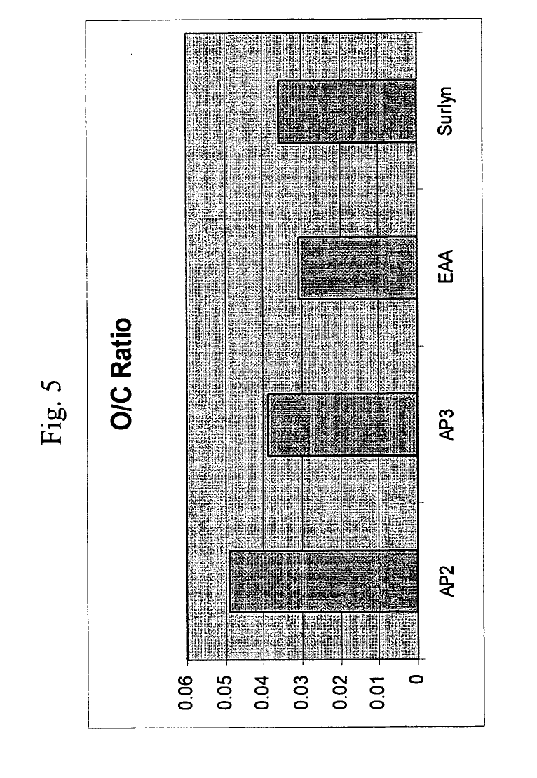

FIG. 5 shows one example of the oxygen/carbon (O/C) ratio determined by X-ray fluorescence detection. The O/C ratio was highest in AP 2 as compared with AP 3, EAA and ionomer tie layers. This indicates a higher presence of oxygen groups in the adhesion promoter of the present invention and, thus, increased bonding with polar materials.

### Example 5

Extrusion lamination was performed to test peel resistance using different tie layers. Kraft Paper (10 mil) and 2 mil metallized PET film were used as substrates. A Randcastle™ extrusion coat/lamination line was used to laminate the substrates. The extrusion lamination was performed using a Microtruder™ 1″ diameter 3:1 compression single screw with a die width of 10 inches at a speed of 10 feet/minute and 25 RPM. The thickness of the monolayer coating was 1 mil or 25 microns. Different melting temperatures were used depending on the tie layer used: lonomer (560° F.), EAA (450° F.) and AP (360° F.).

Peel resistance (adhesive bond strength) was measured by the T-Peel test using a tensile test machine. An ASTM D 1876-01 was used to measure peel strength in terms of load per unit width of bond line.

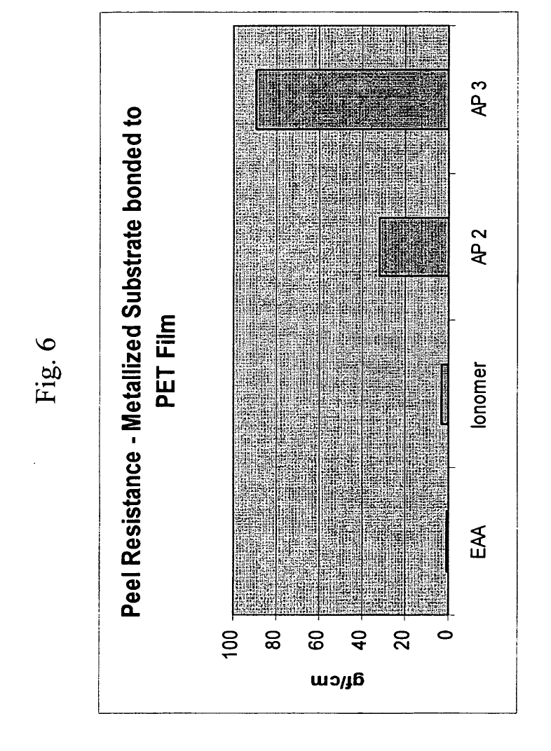

FIG. 6 is an exemplary graph of peel resistance for each of EAA, ionomer, and adhesion promoters AP 2 and AP 3 of the present invention, for metallized substrate bonded to PET film. These results are tabulated in TABLE 1.

TABLE 1

| Primary | | | Melt | Peel |
|---|---|---|---|---|
| Substrate/ | | Thickness | Temperature | Resistance |
| Lamination | Tie Layer | (mil) | (° F./° C.) | (gf/cm) |
| Aluminum/ | Primacor ™ 3440 EAA polymer | 1 | 435/224 | 1.20 |
| PET film | | | | |
| As above | Surlyn ™ 8120 Ionomer | 1 | 560/293 | 2.81 |
| As above | AP-2: Pentaerythritol Rosin Ester | 1 | 360/182 | 32.13 |
| | (30%) + EMA (70%) | | | |
| As above | AP 3: Polymerized rosin (50%) + | 1 | 360/182 | 89.55 |
| | EMA (50%) | | | |

AP 3 tie layer showed the highest peel resistance at 89.55 gf/cm, followed by AP 2 (32.13 gf/cm), ionomer (2.81 gf/cm) and EAA polymer (1.20 gf/cm).

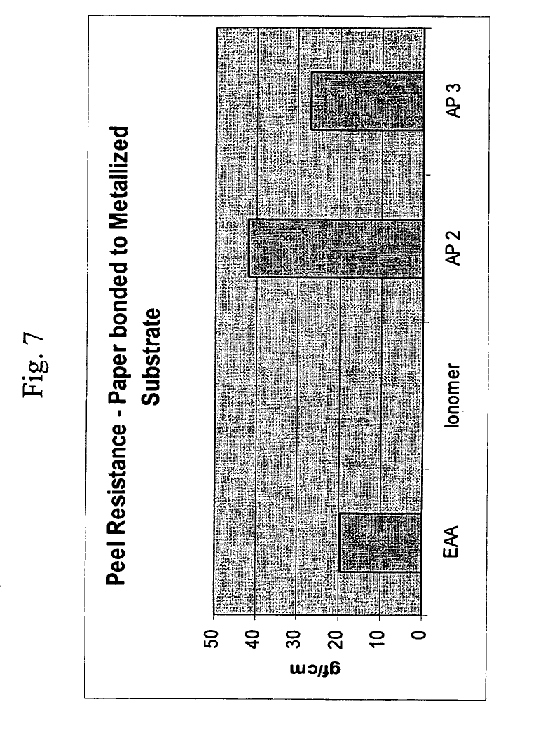

FIG. 7 is an exemplary graph of peel resistance for each of EAA, ionomer, and adhesion promoters AP 2 and AP 3 of the present invention, for metallized substrate bonded to paper. These results are tabulated in TABLE 2.

TABLE 2

| Primary | | | Melt | Peel |
|---|---|---|---|---|
| Substrate/ | | Thickness | Temperature | Resistance |
| Lamination | Tie Layer | (mil) | (° F./° C.) | (gf/cm) |
| Paper/ | Primacor 3440 EAA polymer | 1 | 435/224 | 19.3 |
| Aluminum | | | | |
| As above | Surlyn 8120 Ionomer | 1 | 560/293 | 0 |
| As above | AP2: Pentaerythritol rosin ester | 1 | 360/182 | 42.16 |
| | (30%) + EMA (70%) | | | |
| As above | AP3: Polymerized Rosin (50%) + | 1 | 360/182 | 26.90 |
| | EMA (50%) | | | |

In this example, AP 2 tie layer showed the highest peel resistance at 42.16 gf/cm, followed by AP3 (26.9 gf/cm) and EAA (19.3 gf/cm). lonomer tie layer showed no measurable peel resistance. Thus, the adhesion promoter of the present invention can be used successfully in extrusion coating or lamination. The compound provides excellent adhesive bonding and peel resistance while combining dissimilar substrates such as polyester film/metal or paper/metal. The adhesion promoter provides a significant improvement over current commercially-available tie layers. The above-described embodiments of the present invention are intended to be examples only. Alterations, modifications and variations may be effected to the particular embodiments by those of skill in the art without departing from the scope of the invention, which is defined solely by the claims appended hereto.

1. A thermoplastic adhesion promoter concentrate for thermal bonding the surfaces of two dissimilar substrates comprising a pentaerythritol ester of rosin or polymerized rosin incorporated in a functionalized ethylene copolymer.

2. The adhesion promoter of claim 1 further comprising at least one additional olefinic polymer.

3. The adhesion promoter of claim 1 wherein the concentration of pentaerythritol ester of rosin or polymerized rosin is about 1% (w/w) to about 99% (w/w)

4. The adhesion promoter of claim 3 wherein the concentration of pentaerythritol is about 30% (w/w) to about 50% (w/w).

5. The adhesion promoter of claim 1 wherein the copolymer is ethylene methylacrylate.

6. The adhesion promoter of claim 5 wherein the concentration of ethylene methylacrylate is about 1 % (w/w) to about 99% (w/w).

7. The adhesion promoter of claim 6 wherein the concentration of ethylene methylacrylate is about 50% (w/w) to about 70% (w/w).

8. The adhesion promoter of claim 1 wherein the substrates are selected from the group consisting of metal, paper and polymer composition.

9. The adhesion promoter of claim 8 wherein the metal is aluminum.

10. The adhesion promoter of claim 8 wherein the polymer composition is polyethylene.

11. Use of the adhesion promoter of claim 1 for thermal bonding dissimilar substrates.

12. The use of claim 11 wherein the thermal bonding is selected from the group consisting of mono or multilayer extrusion coating and extrusion lamination, mono or multilayer blown and cast films.

13. The use of claim 11 wherein the substrates are thermally bonded at a thermal bonding temperature of between about 260° F. (127° C.) and about 400° F. (204° C.).

14. The use of claim 13 wherein the thermal bonding temperature is about 360° F. (182° C.).

15. The use of claim 11 wherein the substrates are selected from the group consisting of metal, paper and polymer composition.

16. The use of claim 15 wherein the metal is aluminum.

17. The use of claim 15 wherein the polymer composition is polyethylene.

18. A film comprising a first layer bonded to a second layer with the adhesion promoter of claim 1.

19. The film of claim 18 wherein said first and second layers are dissimilar.

20. The film of claim 18 wherein said first and second layers are each selected from the group consisting of metal, paper and a polymer composition.

21. A first substrate bonded to a second substrate with the adhesion promoter of claim 1.
